(19) United States
(12) Patent Application Publication
(10) Pub. No.: US 2005/0079120 A1
(43) Pub. Date: Apr. 14, 2005

(54) Process for production of nano-graphite structure

(76) Inventors: Jun-ichi Fujita, Tokyo (JP); Masahiko Ishida, Tokyo (JP); Fumiyuki Nihey, Tokyo (JP); Yukinori Ochiai, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/503,660

(22) PCT Filed: Jan. 31, 2003
(86) PCT No.: PCT/JP03/00984

(30) Foreign Application Priority Data
Feb. 8, 2002 (JP) 2002032593

(51) Int. Cl. C01B 31/04

(52) U.S. Cl. 423/448

(57) ABSTRACT

The present invention provides a process for producing a nano-graphite structure having a desired two-dimensional or three-dimensional shape, which process possesses enough potential for ultra-fine processing to allow free selection of the size, shape, and position for the construction therefor; typically a process in which the nano-graphite structure 4 is produced by such a way where a nano-structure amorphous carbon structure 2 formed on a substrate 1 in advance in the shape of a desired ultra-fine steric configuration by a beam-excited reaction is equipped with catalyst metal atoms such as iron contained therein, and when subjecting the steric structure to a low-temperature heat treatment, the structure is converted into the graphite structure 3 through a catalytic thermal reaction by means of the catalyst metal atoms involved therein, while the shape of steric configuration thereof holds.

### TECHNICAL FIELD

The present invention relates to a nano-graphite structure shaped into an ultra-fine steric configuration and a process for production thereof. More specifically, the present invention relates to a process for producing a nano-graphite structure having a desired two-dimensional or three-dimensional shape.

### BACKGROUND ART

Graphite is a material showing good anisotropic electric conduction and good anisotropic heat conduction and being superior in mechanical strength. A carbon nano-tube is such a material having a carbon atom alignment structure similar to that of Graphite that is formed in the tube like shape with nano-scale diameter. Incidentally to the tubular shape, this carbon nano-tube has unique electrical conductivity and mechanical properties such as Young's modulus close to that of diamond; therefore, it is expected that use of structures made of such a carbon nano-tube will be wildly developed in various application fields in the future. With the synthetic technique currently used in synthesis of a carbon nano-tube, it is possible to synthesize a tubular or horn-shaped product somewhat selectively in a large amount; however, it is difficult to apply the above technique per se in production of a nano-scale structure being formed in any complicated and desired shape, which is composed of the carbon nano-tube.

In addition, as a technique for synthesizing a carbon nano-tube on a Si substrate, there is a method characterized in that a very small pattern of iron or nickel is in advance formed on a Si substrate and then such a metal pattern is used as a seed (catalyst) for catalytic reaction to place a selective restriction on a position for growth of a carbon nano-tube. Specifically, it is a technique in which a raw material such as methane gas or the like is decomposed by using a metal (e.g. iron or nickel) as a catalyst site that is positioned at the surface of a very small pattern of desired shape, and growth of a nano-tube is made out of the carbon atoms originated therefrom, which allows a carbon nano-tube having a desired pattern to be synthesized.

Meanwhile, as another method for enabling selective growth of a carbon nano-tube with the position and shape being controlled, there is a method in which in place of a carbon source obtained by decomposition of a raw material gas such as methane gas or the like, a SiC is used as the basic material, and catalytically growth into a graphite structure is made out from carbon atoms being obtainable by decomposition of SiC (Jpn. J. Appl. Phys. Vol. 37, (1998) pp. L605-L606). In this method, the SiC used as the basic material is decomposed when being heated up, the resulting Si is vaporized, the remaining C is orientated on the surface of SiC used for the basic material and is grown, for example, into a graphite structure such as a carbon nano-tube. By forming a very small pattern beforehand on surface of the SiC used as the basic material, the position and planar shape to be formed can be controlled. However, in these methods in which a very fine pattern set up on a substrate is used to produce a carbon nano-tube layer with the shape corresponding to the pattern, there can be grown, for example, a tubular shape graphite of desired diameter (a nano-tube in a broad sense); however, it is impossible to produce a three-dimensional graphite structure showing a desired shape for external form.

Meanwhile, as for an attempt to produce a carbon nano-tube having a branched structure, there has been reported an example of formation of a Y-shaped structure directed by preformation in which magnesium oxide is employed as a catalyst material to synthesize a Y-shaped branch in the nano-tube corresponding to the crystalline orientation of the magnesium oxide, for example, in Appl. Phys. Lett., 79,1879-1881 (2001). Also, as for a process for forming a graphite structure with T-shaped or branched configuration, for example, such a process reported in Nature 402, 253-254 (1999) gained a graphite structure with T-shaped or branched configuration, in which process a hole having a T-shape or a branched shape is built in an alumina block by means of electric field etching and growth of a graphite is made by using the hole as a template therefor to obtain a graphite structure with T-shaped or branched configuration. Then, the alumina mold is liquated selectively, whereby an intended T-shaped branched graphite structure can be taken out. All these methods being applicable to the production of a branched structure are means suitable for formation of a particular branched structure; however, with these methods, it is impossible to synthesize a three-dimensional graphite structure in such a case that its shape, size and position to be formed on substrate are freely pre-determined.

On the other hand, a technique for growing an amorphous carbon three-dimensional structure by using decomposition reaction of a hydrocarbon compound by means of such an energy source as a focussed ion beam or an electron beam has been reported by Matsui, Fujita, etc. [J. Vac. Sci. Technol. B 16 (6), 3181-3184 (2000)]. In said technique, a hydrocarbon compound gas, for example, a vaporized aromatic hydrocarbon such as pyrene or phenanthrene, is sprayed on a specific position on a substrate surface to which a focussed ion beam or an electron beam is partially applied. The hydrocarbon compound molecules being adsorbed on the substrate surface are decomposed by the secondary electrons released from the position irradiated with the electron beam or the ion beam, and amorphous carbon as a decomposition product grows locally into a structure.

In the growth of amorphous carbon using the above technique, by well controlling the partial pressure of raw material gas, the temperature of substrate surface and the beam scanning condition for the irradiation, the in-plane migration of the active species (e.g. carbon) formed by decomposition is utilized to allow also the growth in a direction normal to the direction of the beam irradiation, i.e. a lateral direction growth to take place. It is reported that by combining this lateral direction growth and the rotational scanning of the irradiation beam, even a three-dimensional amorphous carbon structure of nano-scale, such as wine glass, nano-coil or nano-drill can be produced. It has been revealed that with such a technique using a focussed ion beam or an electron beam as an energy source, a fine diameter of the ion beam is successfully used to control the size of processing within the precision of several nano-meters and further to produce a three-dimensional hollow structure, and therefore, the technique is a very important nano-processing technique. Such a technique for producing a nano-scale three-dimensional structure made from amorphous carbon is considered to be applied to, for example, nano-scale mechanical device (NEMS) or bio-electronics, and further is expected to be applied to such a wider range of fields including medical care, aerospace engineering and next-generation electronics such as quantum-processing computer.

### DISCLOSURE OF THE INVENTION

The nano-scale amorphous carbon three-dimensional structure being producible by the process described above attains a hardness (a Young's modulus) as high as 600 to 800 GPa by itself [J. Vac. Sci. Technol. B 20(6), 2686-2689 (2002)], and accordingly is per se in very wide industrial uses including such devices reduced to practice as filters utilizing resonance phenomenon, nano-mechanical devices or the like. Further, the high-hardness amorphous carbon exhibits a strong dielectric strength for insulation as it has the structure in which a bond of sp² hybrid type and a bond of sp³ hybrid type are involved at the state of random mixture. However, in the high-hardness amorphous carbon, change in its structure induced by a heat-treatment, etc. may affect easily its properties, for instance, which results in a reduction in hardness or an increase in electrical conductivity.

Hence, it is desired to develop a process applicable to production of a nano-scale three-dimensional structure formed in desired shape, which is composed of a carbon material of graphite structure having a high Young's modulus and being free from further structural change caused by a heat treatment, etc. in place of a high-hardness amorphous carbon.

The present invention solves the above-mentioned problems, and thus the aim of the present invention is to provide
a process for producing a nano-graphite structure having a desired two-dimensional or three-dimensional nano-scale steric configuration, which process possesses as high potential for ultra-fine processing enough to allow free selection of the size, shape, and position for the construction therefor as that of the technique for growing the nano-scale three-dimensional amorphous carbon structure with the size, shape, and position for the construction freely chosen, which is obtainable by use of decompositive reaction of a hydrocarbon compound by means of such an energy source as a focussed ion beam or an electron beam, and also
a nano-graphite structure being producible by applying the same process.

The present inventors made a study diligently in order to solve above-mentioned problems. As a result, the present inventors found out that high-hardness amorphous carbon has such a feature that its internal structure is changed when subjected to a heat treatment, and in such a case, in particular when the amorphous carbon being equipped with catalyst metal atoms present within the inside thereof or on the surface thereof is subjected to a low-temperature heat treatment, the amorphous carbon can be selectively graphitized by a catalytic thermal reaction. The present inventors further found out that when there is employed, as the high-hardness amorphous carbon, a nano-scale amorphous carbon structure with desired size, shape, and position for the construction therefor, which is producible by, for example, use of decompositive reaction of a hydrocarbon compound by means of an energy source such as a focussed ion beam or an electron beam, the structure is totally graphitized by the catalytic thermal reaction when subjected to said low-temperature heat treatment, and as the result, there can be produced a nano-graphite structure keeping the ultra-fine two-dimensional or three-dimensional configuration thereof. The present inventors completed the present invention based on these findings.

Accordingly, the process for producing a nano-graphite structure according to the present invention is
a process for producing a nano-graphite structure having a desired two-dimensional or three-dimensional nano-scale steric configuration, characterized in that the process for producing the nano-graphite structure comprises a step of applying a heat treatment to a steric structure which is an amorphous carbon structure having a nano-scale steric configuration equivalent to said desired two-dimensional or three-dimensional nano-scale steric configuration and is equipped with catalyst metal atoms involved within the inside thereof or adhered on the surface thereof, to graphitize said amorphous carbon thereof and convert the structure to a graphite structure keeping the shape of nano-scale steric configuration.

Furthermore, in the process for producing a nano-graphite structure according to the present invention, there can be preferably used iron, nickel or molybdenum as said catalyst metal atoms. Additionally, said heat treatment is preferred to be a heat treatment at a low temperature in which the treatment temperature is selected within a range of 700° C. to 900° C., depending upon the kind of said catalyst metal atoms.

Meanwhile, in the process for producing a nano-graphite structure according to the present invention, said amorphous carbon structure having the nano-scale steric configuration may be an amorphous carbon structure having a hollow three-dimensional steric configuration formed in nano-scale, which is constructed through a decompositive synthetic reaction by means of a focussed ion beam by using at least hydrocarbon molecules as a reaction precursor for carbon source therefor. For instance, said amorphous carbon structure having the nano-scale steric configuration may be an amorphous carbon structure having a hollow three-dimensional steric configuration formed in nano-scale, which is constructed through a decompositive synthetic reaction by means of an electron beam by using at least hydrocarbon molecules as a reaction precursor for carbon source therefor.

In addition, said amorphous carbon structure having a nano-structure steric configuration may be a structure being constructed through a decompositive synthetic reaction by means of a beam source for excitation chosen from a focussed ion beam or an electron beam by using organometal molecules and high-molecular hydrocarbon molecules as reaction precursors for carbon source therefor, and involving the metal element contained in said organometal molecules within the inside of the steric structure formed, as the catalyst metal atoms. In such a case, the process may be constituted as a process for producing the nano-graphite structure characterized in that said amorphous carbon structure having a nano-scale steric configuration is a structure containing said catalyst metal atoms in the whole portion of the steric structure formed and, when subjected to a heat treatment, said amorphous carbon thereof is graphitized by the catalytic thermal reaction to be converted into a three-dimensional graphite structure. Alternatively, the process may be constituted as a process for producing the nano-graphite structure characterized in that said amorphous carbon structure having a nano-scale steric configuration is a structure containing said catalyst metal atoms in a portion of the steric structure formed, and when subjected to a heat treatment, said amorphous carbon thereof is graphitized by a catalytic thermal reaction to be converted into a three-dimensional graphite structure.

Further, in the process for producing a nano-graphite structure according to the present invention, the process may be constituted as a process for producing the nano-graphite structure characterized in that said amorphous carbon structure having a nano-scale steric configuration is a structure constructed on the surface of a substrate, which is formed in such a way where said catalyst metal atoms are adhered onto said surface of a substrate by vapor deposition or by sputtering, prior to the construction thereof, to be equipped with the catalyst metal atoms adhered on the bottom surface of the steric structure, and
when subjected to a heat treatment, said amorphous carbon thereof is graphitized by a catalytic thermal reaction to be converted into a three-dimensional structure made of graphite. Alternatively, the process may be constituted as a process for producing the nano-graphite structure characterized in that said amorphous carbon structure having a nano-scale steric configuration is a structure being equipped with said catalyst metal atoms that are adhered by vapor deposition or by sputtering, post to the constriction thereof, on said surface of the structure, and
when subjected to a heat treatment, said amorphous carbon thereof is graphitized by a catalytic thermal reaction to be converted into a three-dimensional structure made of graphite.

Furthermore, the present invention also provides an invention of nano-graphite structure that is producible by use of the above-described process for producing a nano-graphite structure according to the present invention. That is, the nano-graphite structure according to the present invention is a graphite structure having a desired two-dimensional or three-dimensional nano-scale steric configuration, characterized in that the nano-graphite structure is to be produced by a process for production of a nano-graphite structure according to the present invention that has any one of constitutions as defined above.

### BRIEF DESCRIPTION OF THE DRAWINGS

FIG. 1 is a sectional view schematically showing an example of embodiments of the process for producing a nano-graphite structure according to the present invention, which is applicable to production of a pillar-shaped graphite structure.

FIG. 2 is a sectional view schematically showing an example of a pillar-shaped graphite structure being producible by applying the process for producing a nano-graphite structure according to the present invention.

FIG. 3 is a sectional view schematically showing another example of embodiments of the process for producing a nano-graphite structure according to the present invention, which is applicable to production of a pillar-shaped graphite structure.

FIG. 4 is a sectional view schematically showing the third example of embodiments of the process for producing a nano-graphite structure according to the present invention, which is applicable to production of a pillar-shaped graphite structure.

FIG. 5 is a sectional view schematically showing the fourth example of embodiments of the process for producing a nano-graphite structure according to the present invention, which is applicable to production of a pillar-shaped graphite structure.

FIG. 6 is a sectional view schematically showing an example of embodiments of the process for producing a nano-graphite structure according to the present invention, which is applicable to production of a graphite structure with Y-branching shape.

FIG. 7 is a sectional view schematically showing an example of a graphite structure with Y-branching shape, which is producible by applying the process for producing a nano-graphite structure according to the present invention.

### BEST MODE FOR CARRYING OUT THE INVENTION

The process for producing a nano-graphite structure according to the present is such a process characterized in that, an amorphous carbon structure having a desired ultra-fine two-dimensional or three-dimensional steric configuration is beforehand produced, which is in such a state that catalyst metal atoms of iron or the like are contained in the inside of the structure or catalyst metal atoms are adhered on the surface thereof; when the whole portion of the nano-scale amorphous carbon structure is subjected to a heat treatment at as low temperatures as about 700° C., progress of selective graphitization thereof is made by a catalytic thermal reaction induced by the catalyst metal atoms involved therein; finally, the amorphous carbon is converted into nano-graphite crystals being stable structurally and chemically, while the ultra-fine steric configuration originally formed is kept.

The present invention is explained in more detail below.

In the process for producing a nano-graphite structure according to the present invention, there is used, as the starting material, an amorphous carbon structure prepared beforehand in shape having a desired ultrafine two-dimensional or three-dimensional steric configuration. In producing such a nano-scale amorphous carbon structure, there can be used the above-mentioned technique for growing an amorphous carbon three-dimensional structure by decomposition reaction of a hydrocarbon compound using a focussed ion beam or an electron beam as an energy source. Specifically, using a focussed ion beam apparatus or an electron beam apparatus, a beam is applied to a desired position on a substrate and, simultaneously therewith, a reaction precursor such as an aromatic hydrocarbon gas is fed locally as a carbon source to give rise to its decomposition reaction, whereby a nano-scale amorphous carbon structure can be formed.

In the above decomposition reaction due to the irradiation with an ion beam or an electron beam, while there is a direct reaction between the reaction precursor and the primary ion species or primary electrons of high energy, the main mechanism for the decompositive formation reaction is generally a decomposition reaction of the reaction precursor being adsorbed on the substrate surface which is caused by a plurality of secondary electrons generated by impact of high-energy primary species or primary electrons on the substrate surface. For instance, in the focussed ion beam apparatus or electron beam apparatus, recent improvement in performance of these beam apparatus provides the effective beam diameter of the electron or ion beam irradiation being as small as 5 to 7 nm. When a high-energy electron beam or ion beam of such a small diameter is applied onto a substrate or a decomposition product, for example, for irradiation with an ion having an accelerated energy of about 30 keV, the depth of its penetration reaches several tens of nano-meters; in this case, a spread of about several tens of nano-meters takes place owing to forward scattering. There occur, as the elementary processes taking place during the impact, via an Auger mechanism, a excitation mechanism of outer shell electrons of atom, and an inelastic scattering process, secondary electrons having an energy of several eV to several keV are released. The cross section for reaction of such secondary electrons of low energy to the reaction precursor is so large that the secondary electrons react efficiently with the reaction precursor adsorbed on the substrate surface, and thereby the reaction precursor is decomposed in a non-equilibrium state to form amorphous carbon.

Therefore, as for the amorphous carbon structure produced thereby, it is possible to initiate a growth in a much wider range than the effective diameter of the electron beam or ion beam irradiated thereto. For example, when there is used a focussed ion beam apparatus using a Ga+ion having an accelerated energy of 30 keV, the impact depth (the penetration length) of the primary ion is about 20 nm and the scattering length of generated secondary electrons in graphite is about 20 nm; therefore, the growth of amorphous carbon is initiated in a range larger than the beam diameter of the primary ion beam. For example, in a decomposition reaction of phenanthrene used as a reaction precursor, it is reported that production of an amorphous carbon pillar of about 80 nm in diameter is possible by using a Ga⁺ ion beam of 5 nm in diameter.

In addition, In the course of growing a pillar-shaped ultra-fine amorphous structure, when the center of the position of an irradiation beam is shifted from the pillar center, the range of scattering of secondary electrons generated therefrom is shifted correspondingly. As a result, secondary electrons are released from the side wall of the top end of the growing pillar and the side wall of the top end becomes a new growing point. Hence, an overhanging new branch stretches toward the lateral direction from the side wall of the pillar top end. When this lateral direction growth and beam rotational scanning are combined, there can be produced a nano-scale amorphous carbon structure having a desired ultra-fine structure such as wine glass shape or coil shape both having a hollow portion in the center, which were reported by, for example, Matsui, Fujita, etc. [L. Vac. Sci. Technol. B 16 (6), 3181-3184 (2000)].

Incidentally, when a nano-scale amorphous carbon steric structure is produced by a decompositive formation reaction using a focussed ion beam, in particular, for such growth condition that phenanthrene is used as a reaction precursor and a Ga⁺ ion of 30 keV is employed therefor, a growth speed of about 1 μm/min is obtained by selecting, for example, an ion current of 1 nA and a raw material gas partial pressure of 1×10⁻⁶ Torr.

Furthermore, It is also possible to produce a nano-scale amorphous carbon steric structure by a decompositive formation reaction using an electron beam. In this case, as the accelerated energy of the electron beam used therein is chosen in lower acceleration energy, the shape controllability of the steric structure obtained is better. That is, if the acceleration voltage of electrons is higher, the penetration length of primary electrons in amorphous carbon is larger; the primary electrons applied happen to permeate the layer of deposited amorphous carbon and reach the surface of the substrate which is un-intentioned; consequently, by-products are formed on the position un-intended; as a result, it may be a factor for lowering the shape controllability. Meanwhile, with primary electrons of lower acceleration, the penetration length is smaller; incidentally thereto, the amount of the secondary electrons released within the amorphous carbon deposit becomes relatively larger; and the shape controllability becomes better. Consequently, the production of an ultra-fine steric structure at high stability and high reproducibility becomes easier.

In the present invention, there can be used a nano-scale amorphous carbon structure containing catalyst metal atoms therein. For example, when, in producing an amorphous carbon structure utilizing the above-mentioned reaction by means of excitation with electron beam or ion beam, there are used, as reaction precursors, not only hydrocarbon molecules but also organometal molecules containing catalyst metal atoms to obtain the structure being auto-doped, in the course of growth, with the catalyst metal atoms available-form the decomposition of the organometal molecules. In this technique, it is desired that the hydrocarbon molecules and organometal molecules both used as reaction precursors are decomposed in a state that they are adsorbed on the surface targeted. As the hydrocarbon molecules, there can be used vapor of a high-molecular hydrocarbon, for example, vapor of a polycyclic aromatic hydrocarbon such as phenanthrene. As the organometal molecules, there can be used, for example, ferrocene that is an organoiron compound containing iron fit to catalyst metal atoms, and metallocenes or metal carbonyl compounds such as nickel carbonyl and molybdenum carbonyl, which all contain catalyst metal atoms. Besides, as for the catalyst metal atoms usable therefor, there can be used iron, in addition to nickel and molybdenum, alloys and mixtures thereof, and further metal elements which can function as a catalyst in the above-mentioned growth of a nano-tube by a decompositive formation reaction of methane gas.

Alternatively, there can be used such method in which catalyst metal atoms are adhered in advance onto the surface of a substrate, and then amorphous carbon structure are constructed thereon, whereby formed is a nano-scale amorphous carbon structure having the catalyst metal atoms adhered selectively on the bottom, i.e. on the side contacting with the surface of the substrate. It is also possible to produce a nano-scale amorphous carbon structure and then adhering catalyst metal atoms onto the surface of the structure by vapor deposition or sputtering.

Incidentally, in the amorphous carbon, the content of the catalyst metal atoms added locally thereto can be selected in a range of, for example, several % to ten and odd % in terms of a ratio of numbers of atoms represented by (catalyst metal atoms)/(catalyst metal atoms+carbon atoms). When first being adhered on the surface and then being diffused therein, the content of the catalyst carbon atoms in the resulting amorphous carbon can be selected also in a range of several % to ten and odd % in terms of a ratio of numbers of atoms represented by (catalyst metal atoms)/(catalyst metal atoms+carbon atoms). On the other hand, when being added into the whole portion of the amorphous carbon, the content of the catalyst metal atoms in the resulting amorphous carbon can be selected at a significantly lower level than that for the above-mentioned case where being added locally.

Furthermore, In the present invention, when, in the process for producing an amorphous carbon steric structure by the above-mentioned reaction by means of beam-excitation, there is used such a method in which the doping the catalyst metal atoms in the amorphous carbon steric structure is conducted by using organometal molecules and high-molecular hydrocarbon molecules, as reaction precursors, the content of the catalyst metal atoms in the structure is controlled well by using a plurality of gas feeding nozzles as means for supplying raw material gases and by feeding a hydrocarbon gas (e.g. a phenanthrene gas) and an organometal gas (e.g. a ferrocene gas) independently. Meanwhile, when catalyst metal atoms are added only to a portion of the amorphous carbon steric structure, there can be chosen such a manner in which the organometal gas is fed only to the required portion thereof by using the means for feeding separately and independently as described above. When the growth conditions, etc. have been well established, it is possible to employ such a way wherein a plurality of raw materials are mixed beforehand at a given ratio, and then the resulting mixture of raw materials is gasified by heating to feed.

In the production process of the present invention, a nano-scale amorphous carbon structure having a desired two-dimensional or three-dimensional steric configuration is beforehand produced by the way described above to obtain the steric structure being in such a state that catalyst metal atoms such iron, nickel, molybdenum or the like are contained in the inside of the structure or are adhered on the surface thereof; after that, when being subjected to a heat treatment, the amorphous carbon is converted into graphite crystals by a solid-phase catalytic thermal reaction induced by the catalyst metal atoms. Even in this solid-phase reaction, the external shape of the steric structure is maintained; therefore, there can be obtained, at a high reproducibility, a nano-scale graphite structure holding the desired steric configuration that has been formed in advance. The solid-phase catalytic thermal reaction induced by the catalyst metal atoms is equivalent to, for example, a reaction in which a binary alloy between graphite and iron gives rise to phase separation at 738° C. and there appear austenite, cementite (Fe₃C) and graphite; therefore, the temperature of the above heat treatment is preferred to be selected at temperatures equivalent to said temperature of phase separation. In the growth of graphite by a solid-phase reaction using iron as catalyst metal atoms, the temperature of the heat treatment differs slightly depending upon, for example, the content of the catalyst metal atoms and the condition of their addition, for example, whether being uniformly involved in amorphous carbon structure or being adhered on the surface thereof, but it is preferred that a heat treatment is conducted in vacuum at the temperatures being selected in levels of about 740° C. In addition, the temperature of the heat treatment may be appropriately selected depending upon the kind, content and addition condition of the catalyst metal atoms used; however, when iron, nickel, molybdenum or the like are used as for catalyst metal atoms, the heat treatment temperature may be chosen from temperatures at which the rapid vaporization of the low-melting metal (e.g. Ga) resulting from ion beam takes place, and is a low temperature, for instance, preferably conducted is heat treatment at such low temperature chosen in range of at least 600° C. or higher, more preferably of 700° C. to 900° C. At least, the low-temperature heat treatment is preferably conducted at a temperature far lower than the temperature at which changes in the internal structure of the amorphous carbon will progress alone without any help of the solid-phase reaction induced by catalyst metal atoms. When said low-temperature heat treatment is conducted, the degree of vacuum is desirably set at least to a degree of vacuum at which the rapid vaporization of the low-melting metal (e.g. Ga) used for ion beam takes place, preferably, for example, 1×10⁻⁶ Torr or less.

In the production process of the present invention, conversion from amorphous carbon into graphite crystals is originated by a solid-phase catalytic thermal reaction with catalyst metal atoms. When there is used, for example, such a structure in which the catalyst metal atoms are selectively adhered on the bottom surface of the amorphous carbon structure, i.e. the portion thereof contacting with the surface of the substrate, or after the formation of a nano-scale amorphous carbon structure, the catalyst metal atoms are selectively adhered by vapor deposition or sputtering on the surface of the structure, the catalyst metal atoms adhered on its surface will diffuse into the inside of the structure with the progress of a solid-phase catalytic thermal reaction, whereby graphitization is advanced. As the result, the graphitization starts from the end surface thereof and spreads over the whole portion of the structure with the advancement of the diffusion front end of the catalyst metal atoms, and thus there is obtained a nano-scale graphite structure resulting from wholly graphitization at a high reproducibility, independent of its external shape.

### EXAMPLES

The present invention is illustrated more specifically below by showing Examples. These Examples presented herein are some of the best modes for carrying out the present invention, but the present invention is not restricted to these specific embodiments.

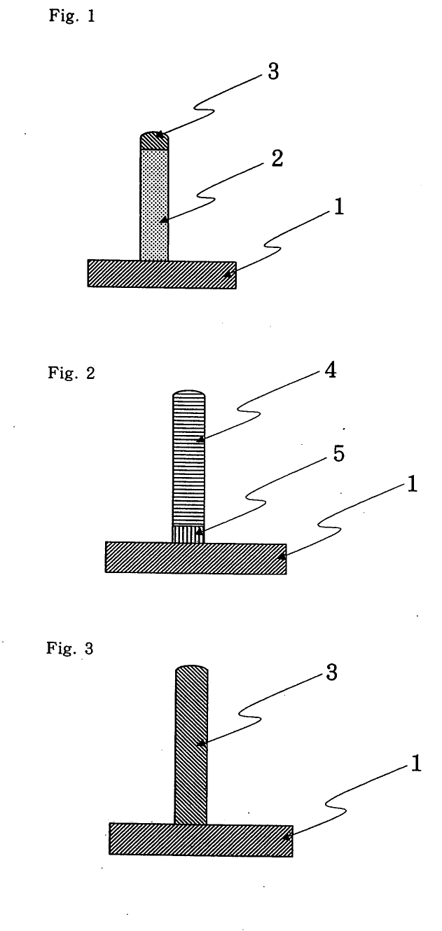

FIG. 1 shows a first embodiment in which the process for producing a nano-graphite structure according to the present invention has been applied to production of a pillar-shaped graphite structure. In particular, FIG. 1 illustrates an example in which used is such a structure doped with iron as catalyst metal atoms selectively in the front end of a pillar-shaped amorphous carbon structure 2 formed on a substrate 1, and it is converted into a pillar-shaped graphite structure by a heat treatment.

The formation of the pillar-shaped amorphous carbon structure 2 on the substrate 1 is conducted by a decompositive formation reaction of a reaction precursor by means of a focussed ion beam. A focussed ion beam of Ga⁺ is applied to a target position on the substrate 1 and, simultaneously therewith, a reaction precursor gas is introduced thereon. In this case, vapor of phenanthrene is used for formation of amorphous carbon, and ferrocene is used for doping of catalyst metal atoms. First, a phenanthrene crucible is heated up to about 80° C. and the phenanthrene vapor obtained by sublimation is used as a reaction precursor for the reaction by means of beam-excitation. In this case, the partial pressure of the phenanthrene gas in a reactor is 2×10⁻⁵ Pa. The phenanthrene vapor is fed from the crucible and injected, via a gas tube and a gas nozzle, to the vicinity of the position for beam irradiation on the substrate 1. Incidentally, the vapor is injected as a gas jet from the gas nozzle and its actual partial pressure being locally obtained in the vicinity of the beam application position is presumed to be higher by several digits than its average partial pressure in the reactor. When a Ga⁺ ion beam of 1 nA ion current is applied, the decomposition of phenanthrene progresses at the position of ion beam irradiation, and thereby an amorphous carbon pillar of nano-scale such as shown in FIG. 1 is grown on the substrate 1. When the position for beam irradiation is scanned in, for example, an X-Y direction, there can be produced a three-dimensional structure of desired shape, such as beaker or bellows like shape or wine glass like form, depending upon the position of scanning.

The advantage of the process for producing an amorphous carbon structure by using an ion beam is that the process is suitable for production of a three-dimensional structure having a desired shape such as mentioned above. This high shape controllability owes mainly to a fact that the penetration and diffusion lengths of ion beam into substance are relatively short. That is, it is due to the feature that owing to the short penetration and diffusion lengths of beam, the region where the secondary electrons generated by ion impact occur is quite limited. Thus, the region of occurrence of secondary electrons is limited to a center at the irradiation position of ion beam and a range of several tens of nano-meters surrounding the center. In this very small region alone, there occurs a decompositive formation reaction of a reaction precursor layer adsorbed on the substrate, whereby growth is attained in a nano-scale pillar shape.

At that time, when the position of ion beam irradiation is shifted gradually from the pillar center in the radical direction thereof, the region of occurrence of secondary electrons shifts correspondingly thereto. For example, when the beam position is laterally moved at the top end of the pillar, occurrence of secondary electrons begins at the new position to be moved, i.e. at the pillar side wall. As a result, a decompositive formation reaction takes place onto the side wall and growth of amorphous carbon begins in the direction to the side wall (in the direction for movement). That is, by conducting scanning of ion beam, formation of an overhanging shape becomes possible. However, since the region of occurrence of secondary electrons is narrow, the growth range at the side wall is limited to several tens of nano-meters, and therefore, the construction formed on the side wall neither reaches the substrate surface nor contacts therewith.

Accordingly, when the position of ion beam irradiation is scanned in an X-Y direction to give rise to rotary motion and the growth rate of amorphous carbon in upper (Z) direction is large enough to prevent it from making contact with the originally grown portion after one circular turn, there can be formed a coil spring-like structure. When the rotational speed of beam scanning is larger, the growth per each rotation overlaps with each other in a Z direction, and the rotational radius for beam scanning is changed periodically, there can be gained formation of an amorphous carbon in bellows or beaker shape. Further, when there are combined a grown portion of a ellipsoidal shape obtained by such a rotary motion for beam scanning and a grown portion of a pillar shape obtained by fixation of position for beam irradiation, there can be obtained a non-uniform shape such as wine glass, comprising of a pillar-shaped leg portion and an ellipsoidal cup portion.

Further, when, in the course of production of an amorphous carbon structure, application of ion beam is stopped temporarily to pause the growth and then the position of ion beam irradiation is shifted away to other separate position on the already produced structure, growth can be restarted on the new irradiation position. Therefore, by utilizing this technique, there can be produced, for example, an amorphous carbon structure having a branch stretched at the middle, such as shown in FIG. 6, and a desired structure having, for example, T-shape branch or Y-shape branch can be produced. Such a branched structure is very important in production of devices or nano-mechanical structural parts.

Meanwhile, it is possible to conduct such a reaction by means of excitation with an electron beam in place of a focussed ion beam. When an electron beam is used, the penetration length of electrons is far larger than that of ions for the same accelerated energy used; therefore, occasionally the electrons may pass through a nano-scale amorphous carbon structure being grown. Hence, when there is adopted a reaction by means of beam excitation using an electron beam, an electron beam of relatively low accelerated energy is used to shorten the penetration length thereof, whereby can be produced the same steric amorphous carbon structure as that formed using a focussed ion beam. The advantage when using an electron beam is no presence of undesired element in the structure produced, while when an ion beam is used, a penetrated ion species remains in the structure produced, and thus the amorphous carbon structure formed contains an ion source element such as Ga.

In the example shown in FIG. 1, an amorphous carbon pillar is formed by such an method using a reaction by means of an ion beam excitation, after which there is formed, at the front end, a portion being doped with Fe as a catalyst metal 5. At that time, the reaction precursor gas is switched from a phenanthrene vapor to a ferrocene vapor for iron doping. When ferrocene is decomposed by an ion beam, a mixture of Fe and carbon is deposited. In the example of FIG. 1, the thickness of the Fe-containing carbon deposit layer is about 100 nm.

The pillar-shaped amorphous carbon structure locally doped with iron is subjected to a heat treatment in vacuum at about 740° C. for 1 hour. In this heat treatment, the ion species Ga remaining in the amorphous carbon structure, which is a low-melting metal, oozes out at the amorphous carbon pillar surface at the early stage of heat treatment. When heated up to about 600° C., the Ga exuded appears at the surface as a melt, then vaporizes away completely, and does not remain in the pillar. After that, in the step of heat treatment at 740° C., the iron doped in the front end agglomerates and diffuses into the pillar. In this diffusion stage, the amorphous carbon undergoes graphitization catalyzed by iron and, simultaneously therewith, the iron runs through the inside of the pillar coherently and in final reaches the lower end of the pillar. Finally, as shown in FIG. 2, the whole pillar is graphitized and becomes a graphite structure 4 keeping the original shape of the amorphous carbon structure 2; at the lower end of the graphite structure 4 remains a region in which the catalyst metal iron 5 is gathered.

By applying the process of the present invention to a nano-scale amorphous carbon structure producible by the method using a focussed ion beam having a high shape freedom and excellent shape controllability for the form produced thereby, as explained above, there can be graphitized a nano-scale amorphous carbon structure produced in any desired shape. The process of the present invention may be used in the manner described below, for example, when an ion beam of very low accelerated energy is used to shorten its scattering length, an amorphous carbon pillar of very small diameter can be produced thereby; and then when it is graphitized, there can be produced a nano-tube-like graphite structure controlled in position and shape. While conventional nano-tubes are very often synthesized in a pile like form being mixed together in bulk, a nano-tube-like graphite structure can be produced in a strictly controlled shape at a required site alone by applying the process of the present invention. Therefore, not speaking of electronic devices, the process has very wide applications in such a field as bio devices and etc.

The example shown in FIG. 1 is such an embodiment in which an amorphous carbon pillar is doped with iron as catalyst metal atoms using ferrocene, locally at the front end. Alternatively, there can be chosen such an embodiment in which a layer doped locally with iron as catalyst metal atoms is formed in advance on a substrate by using ferrocene and, successively, an amorphous carbon pillar is produced thereon, whereby iron is contained as catalyst metal atoms locally in the lower end (part being grown initially) of the pillar. Even in this embodiment in which iron is doped as catalyst metal atoms locally at the lower end, the whole pillar, when subjected to a similar heat treatment, is graphitized and can be converted into a graphite structure holding the original shape of the amorphous carbon structure.

Furthermore, FIG. 3 shows another embodiment in which the process for producing a nano-graphite structure according to the present invention has been applied to production of a pillar-shaped graphite structure. In particular, FIG. 3 illustrates an example in which used is such a structure doped with iron as catalyst metal atoms wholly in a pillar-shaped amorphous carbon structure formed on a substrate 1, and it is converted into a pillar-shaped graphite structure 3 by a heat treatment.

That is, in producing a pillar-shaped amorphous carbon structure using a reaction by means of an ion beam-excitation, the decompositive formation reaction is carried out by feeding not only phenanthrene but also ferrocene at a given mixing ratio to obtain an amorphous carbon structure 3 doped with iron as catalyst metal atoms uniformly in the whole portion of the pillar. In the center of the pillar structure there is an irrdatiaton spot of ion beam, and the distribution of the ion species Ga remaining therein is concentrated in the center of the pillar structure. When the amorphous carbon structure is subjected to a heat treatment, Ga concentrated in the pillar center slips out and the voids left behind stand as a hollow portion. After that, while the heat treatment is being carried out, the iron atoms doped uniformly in the whole portion of the pillar catalyze the graphitization of the amorphous carbon and gradually gather in the hollow-shaped central axis portion of the pillar, and a graphite structure is formed round the center.

The graphite structure obtained becomes a pillar-shaped graphite structure containing iron as catalyst metal atoms, in the central axis portion, and this featue is important technique in applications for utilizing a catalyst-containing graphite. Incidentally, after forming an opening at the top end of the pillar-shaped graphite structure using a chemical or physical means, for example, ion beam etching, the iron contained in the central axis portion may be removed selectively by applying a chemical treatment.

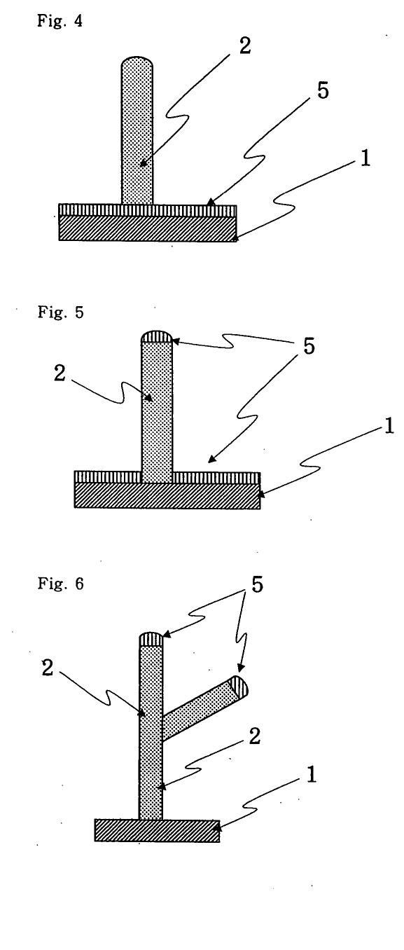

FIG. 4 shows the third embodiment in which the process for producing a nano-graphite structure according to the present invention has been applied to production of a pillar-shaped graphite structure. In particular, FIG. 4 illustrates an example in which used is a structure being prepared by such a way where a film of iron as catalyst metal atoms 5 is deposited in advance by vapor deposition or sputtering to cover on a substrate 1; a pillar-shaped amorphous carbon structure is formed thereon to obtain the structure having catalyst metal atoms adhered on the bottom surface of the amorphous carbon structure; and then it is converted into a pillar-shaped graphite structure by a heat treatment.

In the heat treatment, the iron as catalyst metal atoms adhered on the surface of the amorphous carbon structure diffuses into the amorphous carbon, and in very similar manner to the case of the iron as catalyst metal atoms doped on the lower end, the amorphous carbon undergoes graphitization catalyzed by iron and, simultaneously therewith, the iron runs through the inside of the pillar coherently and in final reaches the top end of the pillar. Finally, the whole pillar is graphitized and becomes a graphite structure keeping the original shape of the amorphous carbon structure; at the top end thereof remains a region in which the catalyst metal iron 5 is gathered.

Incidentally, it is possible as necessary that the coating film of catalyst metal atoms 5 formed on the substrate 1 is processed in, for example, a dot shape patter by lithography and then an amorphous carbon structure having a cross-sectional shape corresponding to the dot is formed only on the dot-shaped coating film by a reaction by means of focussed ion beam excitation with high shape controllability. In this case, no unnecessary coating with the film of catalyst metal atoms subsists on the surface of the substrate 1 and a nano-scale graphite structure of desired shape can be formed at an intended position.

FIG. 5 shows the fourth embodiment in which the process for producing a nano-graphite structure according to the present invention has been applied to production of a pillar-shaped graphite structure. In particular, FIG. 5 illustrates an example in which used is a structure being prepared by such a way where a pillar-shaped amorphous carbon structure is formed on a surface of a substrate 1; and then the film of iron as catalyst metal atoms is deposited by vapor deposition or by sputtering to cover thereon, whereby the catalyst metal atoms 5 is adhered on the front end surface of the pillar-shaped amorphous carbon structure 2; and then it is converted into a pillar-shaped graphite structure by a heat treatment.

In the heat treatment, the iron as catalyst metal atoms adhered on the surface of the amorphous carbon structure diffuses into the amorphous carbon, and in very similar manner to the case of the iron as catalyst metal atoms doped on the front end, the amorphous carbon undergoes graphitization catalyzed by iron and, simultaneously therewith, the iron runs through the inside of the pillar coherently and in final reaches the lower end of the pillar. Finally, the whole pillar is graphitized and becomes a graphite structure keeping the original shape of the amorphous carbon structure; at the lower end thereof remains a region in which the catalyst metal iron 5 is gathered.

Incidentally, in the embodiment shown in FIG. 5 wherein an amorphous carbon structure is formed and then catalyst metal atoms 5 are coated thereon by vapor deposition or by sputtering, as the vapor deposition or sputtering used is not a means for deposition with high directionality, it may happen that iron or the like as catalyst metal atoms adheres in a small amount on the side wall of the pillar, in addition to the front end surface of the pillar-shaped amorphous carbon structure 2. In such a case, in addition to the main process of graphitization developing from the iron film of catalyst metal atoms coated on the front end, there also progresses in parallel subsidiary process of graphitization due to the small amount of iron adhering on the sidewall. As a result, there may be formed a graphite structure comprising, in addition to the stretching of the main graphite crystal domain developing from the front end, a plurality of microscopic domain structures of graphite crystal originated independently from the sidewall. In contrast to a single graphite crystal domain such as a nano-tube, a graphite structure comprising a plurality of microscopic domain structures of graphite crystal has an advantage from the standpoint of mechanical strengths, while such coexistence of the microscopic domain structures of graphite crystal may become retarding factor in the case of utilizing the nano-tube like electrical properties resulting from the single graphite crystal domain. That is, some inclusion of graphite crystal domains of different orientations is effective to provide a graphite steric structure with an isostatic strength distribution.

FIG. 6 is the first embodiment in which the process for producing a nano-graphite structure according to the present invention has been applied to production of a Y-branched graphite structure. In particular, FIG. 6 illustrates an example in which used is such a structure being prepared by such a way where iron as catalyst metal atoms is doped selectively onto each front end of the Y-branched amorphous carbon structure 2 formed on a substrate 1, and it is converted into a Y-branched graphite structure 3 by a heat treatment.

First, a pillar-shaped amorphous carbon structure is produced using a focussed ion beam having excellent shape controllability; and then when the position of beam irradiation is shifted to a site on the side wall of the structure made out, re-growth can be initiated from the irradiation position, whereby a branched structure with Y-shape shown in FIG. 6 can be constructed. In this case, the site for branching off can be set at a desired position by determining a beam-point with use of observed image of secondary ion generated therefrom. Then, the beam-point is gradually moved in the stretching direction of branch and branching is completed. Next, ferrocene as a reaction precursor is fed onto the front ends of the two branches to form, on each front end, a layer doped with iron as catalyst metal atoms 5. The thickness of each layer doped with iron is about 100 nm as mentioned above for the example of FIG. 1. The diameters of both the two branches are about 100 nm.

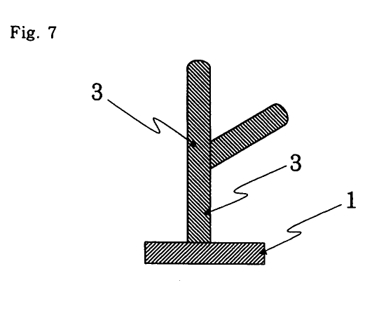

The Y-branched graphite structure 2 having, on each of the front ends thereof, a layer doped with iron as catalyst metal atoms 5 is subjected to a heat treatment at 740° C. for 2 hours to graphitize amorphous carbon of both the two branches, whereby the structure is converted into a nano-scale Y-branched graphite structure 3 holding the original Y-branched configuration, as shown in FIG. 7. In this example as well, each branch is composed of a graphite crystal domain stretched from the front end thereof.

Thus, a nano-scale amorphous carbon three-dimensional steric structure of desired shape can be produced at a desired position with a high position selectivity using a beam-excited reaction, and when heat-treated, each structural unit constituting the three-dimensional steric structure can undergo in parallel graphitization which is induced by catalyst metal atoms. Accordingly, the process for producing a nano-graphite structure according to the present invention can be applied to production of a nano-scale graphite structure having not only a T- or Y-shaped branch but also a desired two-dimensional or three-dimensional configuration. The high freedoms of position and shape control as well as the high controllability thereof are very important in its applications to devices or in biotechnology.

### INDUSTRIAL APPLICABILITY

The process for producing a nano-graphite structure according to the present invention has such a great merit that a nano-scale graphite structure of desired shape can be produced at a desired position with high controllability by using the process in which a nano-scale three-dimensional amorphous carbon structure is in advance produced by a decompositive formation reaction with use of an aromatic hydrocarbon gas or the like as a reaction precursor gas by means of beam-excitation utilizing a focussed ion beam apparatus or an electron beam apparatus; and then when the structure is subjected to a low-temperature heat treatment, graphitization of amorphous carbon can be made with high reproducibility by a catalytic thermal reaction using catalyst metal atoms doped in the structure or catalyst metal atoms adhered on the surface thereof. In addition, the graphite structure producible by applying the process for production of the present invention has high controllability of shape and high freedom in production position, and thus is very effective in application to nano-tube electronics devices or in biotechnology.

1. A process for producing a nano-graphite structure having a desired two-dimensional or three-dimensional nano-scale steric configuration, characterized in that the process for producing the nano-graphite structure comprises a step of applying a heat treatment to a steric structure which is an amorphous carbon structure having a nano-scale steric configuration equivalent to said desired two-dimensional or three-dimensional nano-scale steric configuration and is equipped with catalyst metal atoms involved within the inside thereof or adhered on the surface thereof, to graphitize said amorphous carbon thereof and convert the structure to a graphite structure keeping the shape of nano-scale steric configuration.

2. A process as claimed in claim 1, wherein said catalyst metal atoms are iron, nickel or molybdenum.

3. A process as claimed in claim 1, wherein said heat treatment is a heat treatment at a low temperature in which the treatment temperature is selected within a range of 700° C. to 900° C., depending upon the kind of said catalyst metal atoms.

4. A process as claimed in claim 1, wherein said amorphous carbon structure having the nano-scale steric configuration is an amorphous carbon structure having a hollow three-dimensional steric configuration formed in nano-scale, which is constructed through a decompositive synthetic reaction by means of a focussed ion beam by using at least hydrocarbon molecules as a reaction precursor for carbon source therefor.

5. A process as claime in claim 1, wherein said amorphous carbon structure having the nano-scale steric configuration is an amorphous carbon structure having a hollow three-dimensional steric configuration formed in nano-scale, which is constructed through a decompositive synthetic reaction by means of an electron beam by using at least hydrocarbon molecules as a reaction precursor for carbon source therefor.

6. A process according to claim 1, wherein said amorphous carbon structure having a nano-structure steric configuration is a structure being constructed through a decompositive synthetic reaction by means of a beam source for excitation chosen from a focussed ion beam or an electron beam by using organometal molecules and high-molecular hydrocarbon molecules as reaction precursors for carbon source therefor, and involving the metal element contained in said organometal molecules within the inside of the steric structure formed, as the catalyst metal atoms.

7. A process as claimed in claim 6, wherein said amorphous carbon structure having a nano-scale steric configuration is a structure containing said catalyst metal atoms in the whole portion of the steric structure formed and, when subjected to a heat treatment, said amorphous carbon thereof is graphitized by a catalytic thermal reaction to be converted into a three-dimensional structure made of graphite.

8. A process as claimed in claim 6, wherein said amorphous carbon structure having a nano-scale steric configuration is a structure containing said catalyst metal atoms in a portion of the steric structure formed, and when subjected to a heat treatment, said amorphous carbon thereof is graphitized by a catalytic thermal reaction to be converted into a three-dimensional structure made of graphite.

9. A process according to claim 1, wherein said amorphous carbon structure having a nano-scale steric configuration is a structure constructed on the surface of a substrate, which is formed in such a way where said catalyst metal atoms are adhered onto said surface of a substrate by vapor deposition or by sputtering, prior to the construction thereof, to be equipped with the catalyst metal atoms adhered on the bottom surface of the steric structure, and
when subjected to a heat treatment, said amorphous carbon thereof is graphitized by a catalytic thermal reaction to be converted into a three-dimensional structure made of graphite.

10. A process as claimed in claim 1, wherein said amorphous carbon structure having a nano-scale steric configuration is a structure being equipped with said catalyst metal atoms that are adhered by vapor deposition or by sputtering, post to the constriction thereof, on said surface of the structure, and
when subjected to a heat treatment, said amorphous carbon thereof is graphitized by a catalytic thermal reaction to be converted into a three-dimensional structure made of graphite.

11. A graphite structure having a desired two-dimensional or three-dimensional nano-scale steric configuration, characterized in that the nano-graphite structure is to be produced by a process for production set forth in any one of claims 1 to 10.
